(19) United States
(12) Patent Application Publication
(10) Pub. No.: US 2014/0368155 A1
(43) Pub. Date: Dec. 18, 2014

(54) SMART VEHICLE RESCUE BATTERY APPARATUS

(71) Applicant: MtTek Co., Ltd, TaoYuan City (TW)

(72) Inventor: Job CHEN, TaoYuan City (TW)

(21) Appl. No.: 13/920,601

(22) Filed: Jun. 18, 2013

(51) Int. Cl. B60R 16/033

(52) U.S. Cl. CPC B60R 16/033
USPC 320/104; 307/9.1

(57) ABSTRACT

A smart vehicle rescue battery apparatus includes a battery unit, a first switch unit, a second switch unit, a third switch unit, a fourth switch unit, a control unit and a voltage polarity detection unit. The first switch unit and the fourth switch unit are turned on, when the connection between the first switch unit and the third switch unit is judged to be a positive pole and when the connection between the second switch unit and the fourth switch unit is judged to be a negative pole. The second switch unit and the third switch unit are turned on when the connection between the first switch unit and the third switch unit is judged to be the negative pole and when the connection between the second switch unit and the fourth switch unit is judged to be the positive pole.

### BACKGROUND OF THE INVENTION

1. Field of the Invention

The present invention relates to a vehicle rescue battery apparatus and especially relates to a smart vehicle rescue battery apparatus.

2. Description of the Related Art

The vehicle rescue battery is used to connect to the vehicle battery to start the vehicle engine urgently if the power of the vehicle battery is not enough to start the vehicle engine (for example, the vehicle engine has not been started for a long time).

Some users connect the vehicle rescue battery to the vehicle battery incorrectly (the connections of the polarities of the vehicle rescue battery and the vehicle battery are reversed) although the polarities of the vehicle rescue battery are indicated and marked with different colors. The vehicle computer will be damaged and the vehicle rescue battery will not supply power correctly if the connections of the polarities of the vehicle rescue battery and the vehicle battery are reversed.

### SUMMARY OF THE INVENTION

In order to solve the above-mentioned problems, an object of the present invention is to provide a smart vehicle rescue battery apparatus.

In order to achieve the object of the present invention mentioned above, the smart vehicle rescue battery apparatus is applied to a vehicle battery. The smart vehicle rescue battery apparatus includes a battery unit, a first switch unit, a second switch unit, a third switch unit, a fourth switch unit, a control unit and a voltage polarity detection nit. The first switch unit is electrically connected to the battery unit and the vehicle battery. The second switch unit is electrically connected to the battery unit, the first switch unit and the vehicle battery. The third switch unit is electrically connected to the battery unit, the first switch unit and the vehicle battery. The fourth switch unit is electrically connected to the battery unit, the second switch unit, the third switch unit and the vehicle battery. The control unit is electrically connected to the first switch unit, the second switch unit, the third switch unit and the fourth switch unit. The voltage polarity detection unit is electrically connected to the first switch unit, the second switch unit, the third switch unit, the fourth switch unit, the vehicle battery and the control unit. The voltage polarity detection unit is configured to detect the voltage polarity of the vehicle battery and inform the control unit. The control unit is configured to turn on the first switch unit and the fourth switch unit and turn off the second switch unit and the third switch unit, when the polarity of a contact connecting the first switch unit, the third switch unit and the vehicle battery is judged to be a positive pole and when the polarity of a contact connecting the second switch unit, the fourth switch unit and the vehicle battery is judged to be a negative pole. The control unit is configured to turn on the second switch unit and the third switch unit and turn off the first switch unit and the fourth switch unit, when the polarity of the contact connecting the first switch unit, the third switch unit and the vehicle battery is judged to be the negative pole and when the polarity of the contact connecting the second switch unit, the fourth switch unit and the vehicle battery is judged to be the positive pole.

Moreover, the battery unit is a storage battery.

Moreover, the first switch unit is, for examples but not limited to, a metal oxide semiconductor field effect transistor, a bipolar junction transistor, an insulation gate bipolar transistor, or a silicon controlled rectifier.

Moreover, the second switch unit is, for examples but not limited to, a metal oxide semiconductor field effect transistor, a bipolar junction transistor, an insulation gate bipolar transistor, or a silicon controlled rectifier.

Moreover, the third switch unit is, for examples but not limited to, a metal oxide semiconductor field effect transistor, a bipolar junction transistor, an insulation gate bipolar transistor, or a silicon controlled rectifier.

Moreover, the fourth switch unit is, for examples but not limited to, a metal oxide semiconductor field effect transistor, a bipolar junction transistor, an insulation gate bipolar transistor, or a silicon controlled rectifier.

Moreover, the control unit is, for examples but not limited to, a microprocessor, a microcontroller, or a control circuit having an integrated circuit and electronic components.

Moreover, the voltage polarity detection unit is, for examples but not limited to, a microprocessor, a microcontroller, or a voltage polarity detection apparatus having electronic components.

Moreover, the smart vehicle rescue battery apparatus further includes a charging unit. The charging unit is electrically connected to the first switch unit, the second switch unit, the third switch unit, the fourth switch unit and the battery unit.

### BRIEF DESCRIPTION OF DRAWING

FIG. 1 shows a block diagram of the smart vehicle rescue battery apparatus of the present invention.

### DETAILED DESCRIPTION OF THE INVENTION

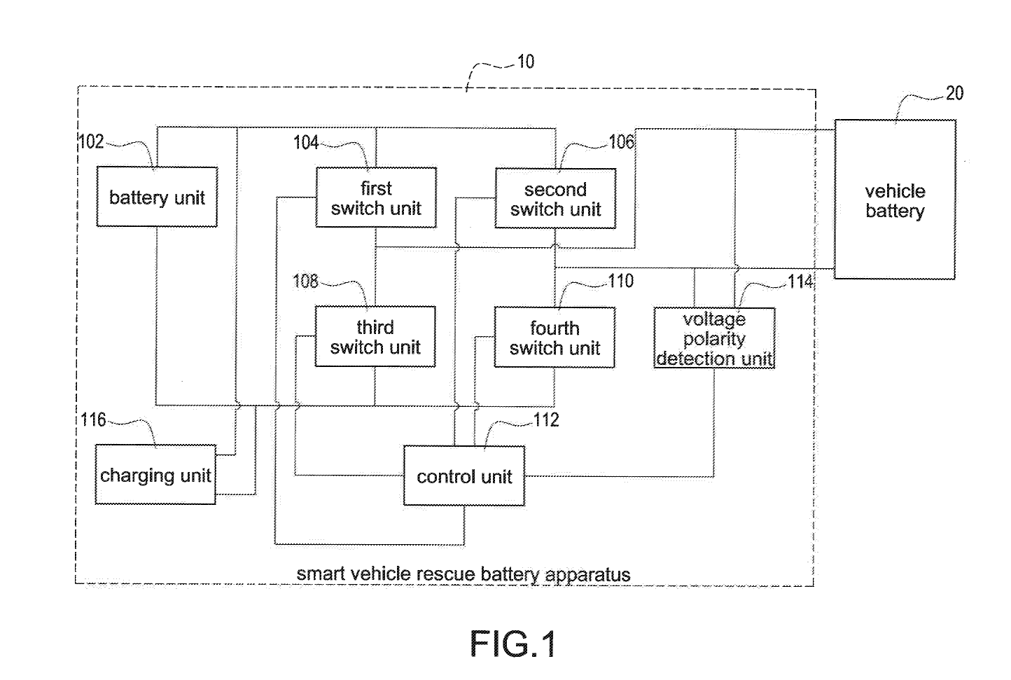

FIG. 1 shows a block diagram of the smart vehicle rescue battery apparatus of the present invention. A smart vehicle rescue battery apparatus 10 is applied to a vehicle battery 20. The smart vehicle rescue battery apparatus 10 is used to connect to the vehicle battery 20 to start a vehicle engine (not shown in FIG. 1) if the power of the vehicle battery 20 is not enough to start the vehicle engine

The smart vehicle rescue battery apparatus 10 includes a battery unit 102, a first switch unit 104, a second switch unit 106, a third switch unit 108, a fourth switch unit 110, a control unit 112, a voltage polarity detection unit 114 and a charging unit 116.

The first switch unit 104 is electrically connected to the battery unit 102 and the vehicle battery A. The second switch unit 106 is electrically connected to the battery unit 102, the first switch unit 104 and the vehicle battery 20. The third switch unit 108 is electrically connected to the battery unit 102, the first switch unit 104 and the vehicle battery 20. The fourth switch unit 110 is electrically connected to the battery unit 102, the second switch unit 106, the third switch unit 108 and the vehicle battery 20. The control unit 112 is electrically connected to the first switch unit 104, the second switch unit 106, the third switch unit 108, the fourth switch unit 110 and the voltage polarity detection unit 114. The voltage polarity detection unit 114 is electrically connected to the first switch unit 104, the second switch unit 106, the third switch unit 108, the fourth switch unit 110, the vehicle battery 20 and the control unit 112. The charging unit 116 is electrically connected to the first switch unit 104, the second switch unit 106, the third switch unit 108, the fourth switch unit 110 and the battery unit 102.

The voltage polarity detection unit 114 is configured to detect the voltage polarity of the vehicle battery 20 and inform the control unit 112.

The control unit 112 is configured to turn on the first switch unit 104 and the fourth switch unit 110 and turn off the second switch unit 106 and the third switch unit 108, when the polarity of a contact connecting the first switch unit 104, the third switch unit 108 and the vehicle battery 20 is judged to be a positive pole and when the polarity of a contact connecting the second switch unit 106, the fourth switch unit 110 and the vehicle battery 20 is judged to be a negative pole.

The control unit 112 is configured to turn on the second switch unit 106 and the third switch unit 108 and turn off the first switch unit 104 and the fourth switch unit 110, when the polarity of the contact connecting the first switch unit 104, the third switch unit 108 and the vehicle battery 20 is judged to be the negative pole and when the polarity of the contact connecting the second switch unit 106, the fourth switch unit 110 and the vehicle battery 20 is judged to be the positive pole.

Moreover, the battery unit 102 is a storage battery. The control unit 112 is, for examples but not limited to, a microprocessor, a microcontroller, or a control circuit having an integrated circuit and electronic components. The voltage polarity detection unit 114 is, for examples but not limited to, a microprocessor, a microcontroller, or a voltage polarity detection apparatus having electronic components.

The first switch unit 104 is, for examples but not limited to, a metal oxide semiconductor field effect transistor, a bipolar junction transistor, an insulation gate bipolar transistor, or a silicon controlled rectifier.

The second switch unit 106 is, for examples but not limited to, a metal oxide semiconductor field effect transistor, a bipolar junction transistor, an insulation gate bipolar transistor, or a silicon controlled rectifier.

The third switch unit 108 is, for examples but not limited to, a metal oxide semiconductor field effect transistor, a bipolar junction transistor, an insulation gate bipolar transistor, or a silicon controlled rectifier.

The fourth switch unit 110 is, for examples but not limited to, a metal oxide semiconductor field effect transistor, a bipolar junction transistor, an insulation gate bipolar transistor, or a silicon controlled rectifier.

The efficiency of the smart vehicle rescue battery apparatus 10 of the present invention is that a vehicle computer (not shown in FIG. 1) will not be damaged and the smart vehicle rescue battery apparatus 10 will supply power correctly even if the connections of the polarities of the smart vehicle rescue battery apparatus 10 and the vehicle battery 20 are reversed.

Although the present invention has been described with reference to the preferred embodiment thereof, it will be understood that the invention is not limited to the details thereof. Various substitutions and modifications have been suggested in the foregoing description and others will occur to those of ordinary skill in the art. Therefore, all such substitutions and modifications are intended to be embraced within the scope of the invention as defined in the appended claims.

What is claimed is:

1. A smart vehicle rescue battery apparatus applied to a vehicle battery, the smart vehicle rescue battery apparatus including:
a battery unit;
a first switch unit electrically connected to the battery unit and the vehicle battery;
a second switch unit electrically connected to the battery unit, the first switch unit and the vehicle battery;
a third switch unit electrically connected to the battery unit, the first switch unit and the vehicle battery;
a fourth switch unit electrically connected to the battery unit, the second switch unit, the third switch unit and the vehicle battery;
a control unit electrically connected to the first switch unit, the second switch unit, the third switch unit and the fourth switch unit; and
a voltage polarity detection unit electrically connected to the first switch unit, the second switch unit, the third switch unit, the fourth switch unit, the vehicle battery and the control unit,
wherein the voltage polarity detection unit is configured to detect the voltage polarity of the vehicle battery and inform the control unit; the control unit is configured to turn on the first switch unit and the fourth switch unit and turn off the second switch unit and the third switch unit, when the polarity of a contact connecting the first switch unit, the third switch unit and the vehicle battery is judged to be a positive pole and when the polarity of a contact connecting the second switch unit, the fourth switch unit and the vehicle battery is judged to be a negative pole;
wherein the control unit is configured to turn on the second switch unit and the third switch unit and turn of the first switch unit and the fourth switch unit, when the polarity of the contact connecting the first switch unit, the third switch unit and the vehicle battery is judged to be the negative pole and when the polarity of the contact connecting the second switch unit, the fourth switch unit and the vehicle battery is judged to be the positive pole.

2. The smart vehicle rescue battery apparatus in claim 1, wherein the battery unit is a storage battery.

3. The smart vehicle rescue battery apparatus in claim 1, wherein the first switch unit is a metal oxide semiconductor field effect transistor, a bipolar junction transistor, an insulation gate bipolar transistor, or a silicon controlled rectifier.

4. The smart vehicle rescue battery apparatus in claim 1, wherein the second switch unit is a metal oxide semiconductor field effect transistor, a bipolar junction transistor, an insulation gate bipolar transistor, or a silicon controlled rectifier.

5. The smart vehicle rescue battery apparatus in claim 1, wherein the third switch unit is a metal oxide semiconductor field effect transistor, a bipolar junction transistor, an insulation gate bipolar transistor, or a silicon controlled rectifier.

6. The smart vehicle rescue battery apparatus in claim 1, wherein the fourth switch unit is a metal oxide semiconductor field effect transistor, a bipolar junction transistor, an insulation gate bipolar transistor, or a silicon controlled rectifier.

7. The smart vehicle rescue battery apparatus in claim 1, further including a charging unit electrically connected to the first switch unit, the second switch unit, the third switch unit, the fourth switch unit and the battery unit.

8. The smart vehicle rescue battery apparatus in claim 1, wherein the control unit is a microcontroller or a microprocessor.

9. The smart vehicle rescue battery apparatus in claim 1, wherein the control unit is a control circuit having an integrated circuit and electronic components.

10. The smart vehicle rescue battery apparatus in claim 1, wherein the voltage polarity detection unit is a microprocessor, a microcontroller, or a voltage polarity detection apparatus having electronic components.
